(19) United States
(12) Patent Application Publication
(10) Pub. No.: US 2014/0118637 A1
(43) Pub. Date: May 1, 2014

(54) TOUCH PANEL

(71) Applicant: PANASONIC CORPORATION, Osaka (JP)

(72) Inventors: Koji TANABE, Osaka (JP); Keishiro MURATA, Kyoto (JP)

(73) Assignee: PANASONIC CORPORATION, Osaka (JP)

(21) Appl. No.: 14/051,296

(22) Filed: Oct. 10, 2013

(30) Foreign Application Priority Data
Oct. 30, 2012 (JP) 2012-238657

(51) Int. Cl. G02F 1/1333

(52) U.S. Cl. CPC G02F 1/13338
USPC 349/12

(57) ABSTRACT

A touch panel includes a light transmissive substrate, an upper electrode, a light transmissive upper adhesive layer, a light transmissive conductive layer, a lower electrode, a lower light transmissive adhesive layer, and a protrusion. The upper electrode is formed on a lower surface of the substrate. The upper adhesive layer is formed on the lower surface of the substrate and a lower surface of the upper electrode. The conductive layer is formed on a lower surface of the upper adhesive layer. The lower electrode is formed on the lower surface of the upper adhesive layer and connected to the conductive layer. The lower adhesive layer is formed on the lower surface of the upper adhesive layer, a lower surface of the conductive layer, and a lower surface of the lower electrode. The protrusion is formed in the upper adhesive layer so as to connect the upper electrode and lower electrode.

### BACKGROUND

1. Technical Field

The present invention relates to a touch panel mainly used for an operation unit of various electronic devices.

2. Background Art

In recent years, functions of various electronic devices such as mobile phones and electronic cameras become more refined and diversified. Among the various types of devices, electronic devices having a configuration in which a light transmissive touch panel is mounted on a front surface of a display device such as a liquid crystal display device are on the increase. A user touches the touch panel with his or her finger while viewing display of the display device provided behind the touch panel therethrough and can thereby switch various functions of the electronic device. As such electronic devices become popular, the touch panel is required to make the display device provided therebehind more visible and to allow reliable operation.

A conventional touch panel will be described with reference to FIG. 4.

In FIG. 4, a dimension of the touch panel is partially enlarged for easy understanding of a configuration thereof.

FIG. 4 is an exploded perspective view of the conventional touch panel. In FIG. 4, reference numeral 1 is a film-like or plate-like light transmissive upper substrate. On a lower surface of upper substrate 1, a plurality of light transmissive and substantially band-like upper conductive layers 2 made of a material such as indium tin oxide are formed so as to extend in a front-rear direction. Moreover, on the lower surface of upper substrate 1, a plurality of upper electrodes 3 made of a material such as silver or carbon are formed in such a manner that one end of each thereof is connected to an end portion of each of upper conductive layers 2 and the other end of each of upper electrodes 3 is drawn to a right end of an outer periphery of upper substrate 1.

Reference numeral 4 is film-like light transmissive lower substrate. On a lower surface of lower substrate 4, a plurality of light transmissive and substantially band-like lower conductive layers 5 made of a material such as indium tin oxide are formed so as to extend in a left-right direction which is a direction perpendicular to the extending direction of upper conductive layers 2. Moreover, on the lower surface of lower substrate 4, a plurality of lower electrodes 6 are formed in such a manner that one end of each thereof is connected to an end portion of each of lower conductive layers 5 and the other end of each of lower electrodes 6 is drawn to a right end of an outer periphery of lower substrate 4.

Reference numeral 7 is a film-like or plate-like light transmissive cover substrate. Lower substrate 4 and upper substrate 1 are stacked on an upper surface of cover substrate 7 and an upper surface of lower substrate 4, respectively, and then bonded to each other by adhesive or the like (not illustrated) to form the touch panel.

The touch panel thus configured is disposed on a front surface of a display device such as a liquid crystal display device and mounted to the electronic device. Upper electrodes 3 and lower electrodes 6 drawn to the right end of the touch panel are electrically connected to an electronic circuit (not illustrated) of the electronic device through a flexible wiring board (not illustrated) or a connector (not illustrated).

In the thus configured touch panel, a user operates the electronic device by touching an upper surface of upper substrate 1 with his or her finger in response to display of the display device provided behind the touch panel in a state where voltage is applied from the electronic circuit to upper and lower electrodes 3 and 6 sequentially. Electrostatic capacitance between upper and lower conductive layers 2 and 5 is changed at a touched portion, and the touched portion is detected by the electronic circuit, whereby switching of various functions of the electronic device can be achieved.

For example, in a state where a plurality of menus are displayed on the display device provided behind the touch panel, the user touches the upper surface of upper substrate 1 with his or her finger at a portion corresponding to a desired menu. Then, a part of electrical charge of upper conductive layer 2 is conducted to the finger, resulting in a change in the capacitance between upper and lower conductive layers 2 and 5 at the touched portion on the touch panel. Then, the electronic circuit detects the capacitance change, thus allowing a desired menu to be selected.

For example, there is known, as prior art document information relating to the invention of this application, Unexamined Japanese Patent Publication No. 2011-146203.

### SUMMARY

However, in the above conventional touch panel, upper substrate 1 having upper conductive layer 2 formed on the lower surface thereof, lower substrate 4 having lower conductive layer 5 on the lower surface thereof, and cover substrate 7 are stacked on each other. This increases the entire thickness of the touch panel, making it difficult to achieve thickness reduction of the touch panel.

The present invention has been made to solve the above conventional problem, and an object thereof is to provide a touch panel capable of reducing the thickness thereof and allowing reliable operation.

A touch panel according to the present invention includes a light transmissive substrate, an upper electrode, an upper adhesive layer, a conductive layer, a lower electrode, a lower adhesive layer, and a protrusion. The upper electrode is formed on a lower surface of the substrate. The upper adhesive layer is formed on the lower surface of the substrate and a lower surface of the upper electrode and has a light transmissive property. The conductive layer is formed on a lower surface of the upper adhesive layer and has a light transmissive property. The lower electrode is formed on the lower surface of the upper adhesive layer and connected to the conductive layer. The lower adhesive layer is formed on the lower surface of the upper adhesive layer, a lower surface of the conductive layer, and a lower surface of the lower electrode and has a light transmissive property. The protrusion is formed in the upper adhesive layer so as to connect the upper electrode and lower electrode. The upper adhesive layer, conductive layer, lower adhesive layer are formed on the lower surface of the substrate in a stacked manner, so that a thickness of the entire touch panel can be reduced. The protrusion formed on the lower surface of the upper electrode contacts the lower electrode, thereby achieving stable connection between the upper and lower electrodes. Thus, a touch panel allowing reliable operation can be obtained.

As described above, according to the present invention, it is possible to realize a touch panel capable of reducing the thickness thereof and allowing reliable operation.

### BRIEF DESCRIPTION OF DRAWINGS

FIG. 1 is a partial cross-sectional view of a touch panel according to an embodiment of the present invention;

FIG. 2 is an exploded perspective view of the touch panel according to the embodiment;

FIG. 3A is a partial cross-sectional view for explaining a manufacturing method of the touch panel according to the present embodiment;

FIG. 3B is a partial cross-sectional view for explaining the manufacturing method of the touch panel according to the present embodiment;

FIG. 3C is a partial cross-sectional view for explaining the manufacturing method of the touch panel according to the present embodiment; and

FIG. 4 is an exploded perspective view of a conventional touch panel.

### DESCRIPTION OF EMBODIMENT

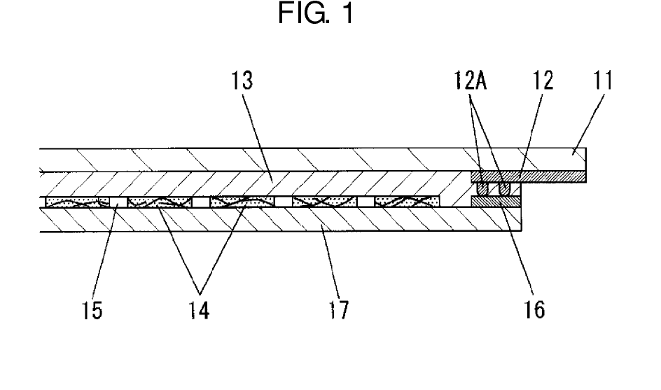

An embodiment of the present invention will be described below with reference to FIGS. 1 to 3C.

In each of FIGS. 1 to 3C, a dimension of a touch panel is partially enlarged for easy understanding of a configuration thereof.

### Exemplary Embodiment

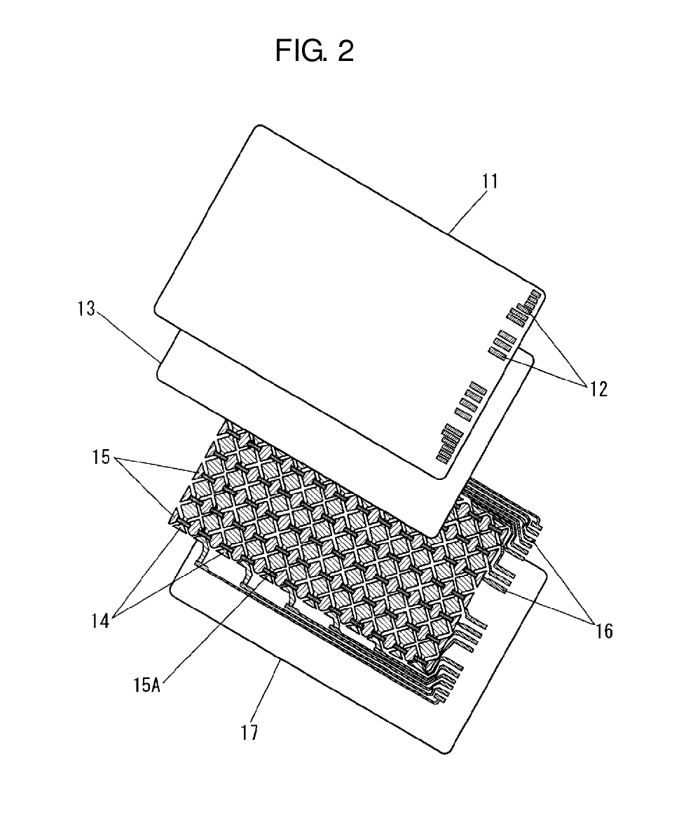

FIG. 1 is a partial cross-sectional view of a touch panel according to an embodiment of the present invention, and FIG. 2 is an exploded perspective view of the touch panel according to the embodiment. In FIGS. 1 and 2, reference numeral 11 is a film-like or plate-like light transmissive substrate. As an example of film-like substrate 11, a resin sheet made of one of polyethylene terephthalate, polycarbonate, cycloolefin polymer, polyethersulfone, or a combination of two or more thereof can be taken. As an example of film-like substrate 11, a substrate made of one of glass and acrylic, or a combination thereof can be taken. Reference numeral 12 is an upper electrode made of one of silver, carbon, and a copper alloy, or a combination of two or more thereof. A plurality of upper electrodes 12 each having a thickness in a range from 2 μm to 30 μm are formed at a right end of an outer periphery of a lower surface of substrate 11 by printing or plating.

Reference numeral 13 is an ultraviolet curable upper adhesive layer made of a resin. The material of the resin is one of acrylate and methacrylate, or a combination thereof, for example. Upper adhesive layer 13 has a light transmissive property. Upper adhesive layer 13 is provided on substantially the entire lower surface of substrate 11 so as to expose a right end of each of upper electrodes 12 and cover a left end thereof. Although upper adhesive layer 13 exposes the right end of each upper electrode 12, the portion to be exposed may be any end portion of each upper electrode 12 or an intermediate portion thereof, because it is only necessary that a part of each upper electrode 12 is exposed so as to be connected to an external connection of each upper electrode 12. Upper adhesive layer 13 may be made of a material having an electron radiation curing property or a thermosetting property, in place of the ultraviolet-curing property.

Reference numerals 14 and 15 are each a light transmissive conductive layer. Conductive layer 14 includes a plurality of square-shaped parts connected in a substantially strip shape so as to extend in a front-rear direction, and a plurality of conductive layers 14 are buried in the lower surface of upper adhesive layer 13. Conductive layer 15 includes a plurality of substantially rectangular-shaped conductive parts. The substantially rectangular-shaped conductive parts are formed for each substantially square-shaped gap in conductive layers 14 and connected in a left-right direction by connection parts 15A each having a conductive property. Connection parts 15A are formed on conductive layer 14 through an insulating layer so as not to electrically contact conductive layer 14. Conductive layer 15 extends in the left-right direction perpendicular to the extending direction of conductive layer 14 in an electrically isolated manner from conductive layer 14. A plurality of conductive layers 15 are also buried in the lower surface of upper adhesive layer 13.

Conductive layers 14 and conductive parts and connection parts 15A constituting of conductive layer 15 are each a part in which a plurality of metal thin wires are distributed in a resin. For example, the resin is made of one of light-transmissive acrylate and light-transmissive methacrylate, or a combination thereof and has the ultraviolet-curing property. The resin has an electron radiation curing property or a thermosetting property, in place of the ultraviolet-curing property. The metal thin wire has a diameter in a range from 10 nm to 300 nm and a length in a range from 1 μm to 100 μm. The material of the metal thin wire is one of silver, silver alloy, copper, copper alloy, a copper-nickel alloy, or a combination of two or more thereof, for example.

Conductive layers 14 and 15 are formed within a formation range of upper adhesive layer 13. That is, conductive layers 14 and conductive layers 15 are all disposed on upper adhesive layer 13 and therefore do not directly contact the lower surface of substrate 11.

Reference numeral 16 is a lower electrode having a thickness in a range from 50 nm to 200 nm and made of copper or a copper alloy. Lower electrode 16 is formed by sputtering and etching a metal. One end of lower electrode 16 is connected to conductive layer 14 or conductive layer 15, and the other end thereof is drawn to a right end of an outer periphery of upper adhesive layer 13 and buried in the lower surface of upper adhesive layer 13. Lower electrode 16 is provided in plural so as to correspond to conductive layers 14 and 15. A leading part between one end and the other end of lower electrode 16 is preferably formed by a thin wire having a line width of 200 μm or less.

A plurality of protrusions 12A formed on a lower surface of upper electrode 12 contact an upper surface of lower electrode 16. That is, upper electrode 12 and lower electrode 16 are electrically connected to each other through protrusions 12A. In FIG. 1, although two protrusions 12A are formed to connect one upper electrode 12 and one lower electrode 16, the number of protrusions 12A may be one or three or more. It is preferable that a cross-sectional area of protrusion 12A parallel to substrate 11 is reduced toward lower electrode 16. This allows protrusion 12A to penetrate upper adhesive layer 13 to reliably contact lower electrode 16. A contact area between protrusion 12A and the lower surface of upper electrode 12 is preferably larger than a contact area between protrusion 12A and lower electrode 16.

In order to obtain the abovementioned shape of protrusion 12A, a silver paste in which conductive beads are previously mixed is screen-printed. For example, a spiked Ni powder having a diameter in a range from 3 μm to 60 μm, precious metal plated beads, and the like are mixed in a silver paste in which a silver powder is dispersed in a dilute solution of resin such as acrylic resin or epoxy resin, and resultant material is screen-printed to form protrusion 12A. Even if insulating beads (e.g., glass beads) are used in place of the conductive beads, conductive protrusion 12A can be formed because the insulating beads are covered by the silver paste.

Another formation method of protrusion 12A includes forming upper electrode 12 using the silver paste through printing, sprinkling conductive beads (e.g., precious metal plated beads) over upper electrode 12 in a state where upper electrode is in an undried state, removing unnecessary beads other than those on a pattern of upper electrode 12 by air blow, followed by drying and fixing.

Reference numeral 17 is a lower adhesive layer having the light transmissive property and ultraviolet-curing property, as is the case of upper adhesive layer 13. Moreover, like upper adhesive layer 13, lower adhesive layer 17 may be made of a material having an electron radiation curing property or a thermosetting property, in place of the ultraviolet-curing property. It is preferable that upper adhesive layer 13 and lower adhesive layer 17 are cured by the same treatment.

Lower adhesive layer 17 covers the lower surface of upper adhesive layer 13, lower electrode 16, conductive layer 14, and conductive layer 15, thereby forming the touch panel.

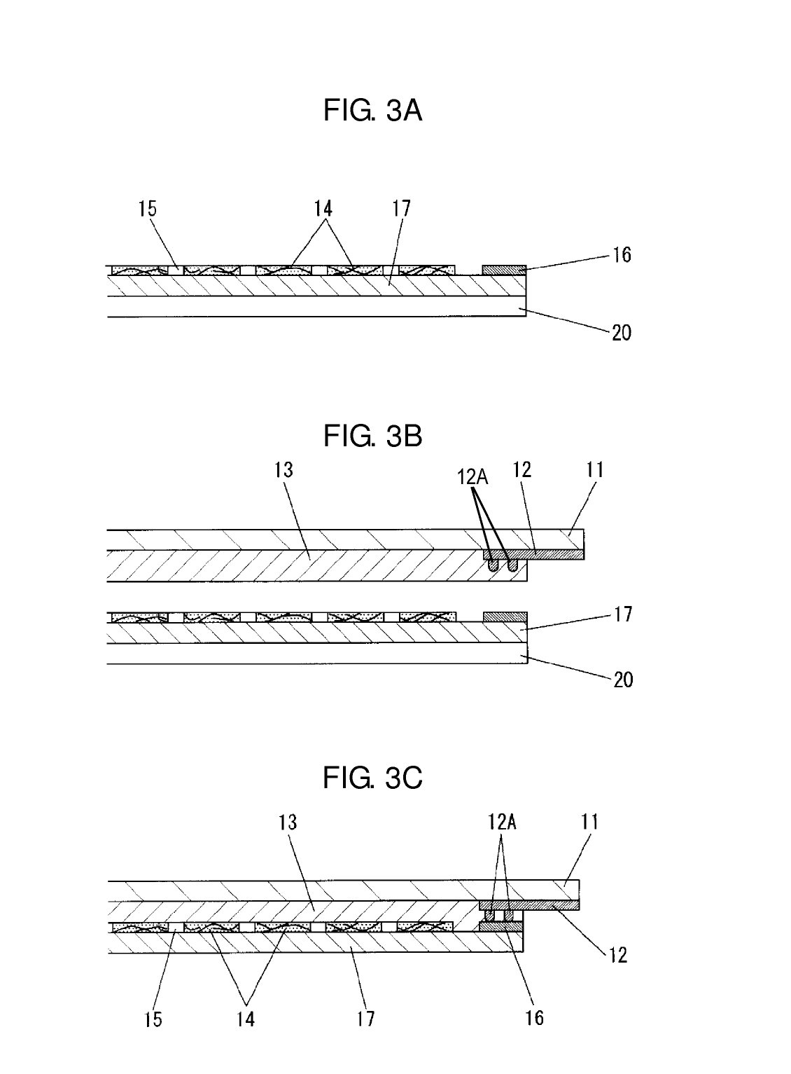

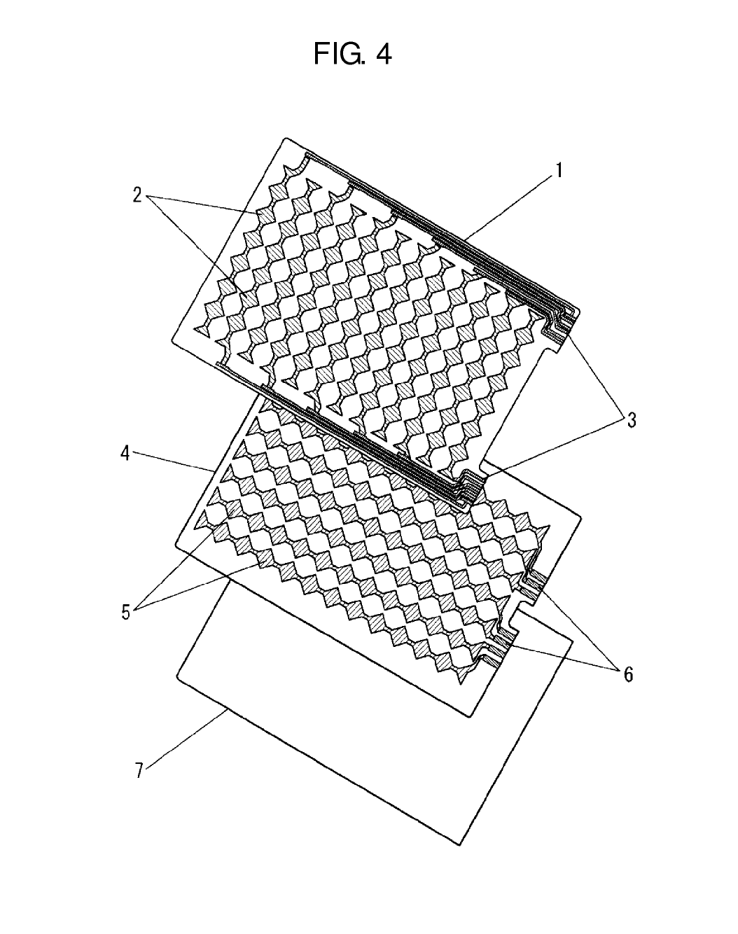

The following describes a manufacturing method of the touch panel according to the present embodiment with reference to FIG. 1 and FIGS. 3A to 3C. FIGS. 3A to 3C are partial cross-sectional views for explaining the manufacturing method of the touch panel according to the present embodiment.

As illustrated in FIG. 3A, in fabricating the touch panel according to the present embodiment, lower adhesive layer 17 is formed on an upper surface of film-like base material 20. Lower adhesive layer 17 is formed in a uniform thickness in a formation range of the touch panel. Subsequently, there are formed the plurality of conductive layers 14 and conductive parts of the plurality of conductive layers 15, and the plurality of connection parts 15A (not illustrated) on an upper surface of lower adhesive layer 17 (connection parts 15A are formed through the insulating layer). At the same time, a plurality of lower electrodes 16 are formed on an upper surface of lower adhesive layer 17 by a sputtering method. In FIG. 3A, the plurality of conductive layers 15 are formed in a depth direction of the view.

Then, as illustrated in FIG. 3B, substrate 11 on the lower surface of which upper electrode 12 and upper adhesive layer 13 are formed is placed on an upper surface of the touch panel of FIG. 3A, and substrate 11 and touch panel are bonded through upper adhesive layer 13. As illustrated in FIG. 3B, before bonding the touch panel of FIG. 3A and substrate 11, protrusion 12A is formed on the lower surface of upper electrode 12, and protrusion 12A is completely covered by upper adhesive layer 13. At this time, upper adhesive layer 13 has not been fully cured. When the touch panel of FIG. 3A and substrate 11 are bonded to each other, protrusion 12A penetrates upper adhesive layer 13 to be connected to lower electrode 16. Thereafter, base material 20 is peeled off from lower adhesive layer 17 and, as illustrated in FIG. 3C, conductive layer 14, conductive layer 15, lower electrode 16, and lower adhesive layer 17 are transferred onto the lower surface of upper adhesive layer 13.

After that, an ultraviolet ray is irradiated onto the touch panel of FIG. 3C in which the plurality of protrusions 12A formed on the lower surface of upper electrode 12 are brought into contact with the upper surface of lower electrode 16 to fully cure upper adhesive layer 13. As a result, there is completed the touch panel in which, as shown in FIG. 1, upper adhesive layer 13 is stacked on the lower surface of substrate 11, and conductive layer 14, conductive layer 15, lower adhesive layer 17, and the like are stacked on the lower surface of upper adhesive layer 13.

In this configuration, the ultraviolet ray is transmitted through substrate 11, upper adhesive layer 13, conductive layer 14, conductive layer 15, and lower adhesive layer 17 each having a light transmissive property, but not transmitted through upper electrode 12 and lower electrode 16. This may result in insufficient curing of upper adhesive layer 13 at a portion between upper electrode 12 and lower electrode 16. To prevent this, upper electrode 12 or lower electrode 16 in an ultraviolet irradiation side may be formed into a substantially lattice shape or a shape having a plurality of through holes. This allows reliable curing of upper adhesive layer 13 at the portion between upper electrode 12 and lower electrode 16.

For example, when the ultraviolet ray is irradiated from lower adhesive layer 17 side, lower electrode 16 may be formed into a configuration including a portion having a line with a width of 200 μm or less or into a lattice shape. This preferably makes it easier for the ultraviolet ray from lower adhesive layer 17 side to be transmitted to upper adhesive layer 13.

In a case where upper adhesive layer 13 has the electron radiation curing property, an electron ray is irradiated in place of the ultraviolet ray to fully cure upper adhesive layer 13, and in a case where upper adhesive layer 13 has the thermosetting property, heating is applied to fully cure upper adhesive layer 13.

The touch panel thus configured is disposed on a front surface of a display device such as a liquid crystal display device and mounted to an electronic device. The plurality of upper electrodes 12 drawn to the right end of the outer periphery of the lower surface of substrate 11 are electrically connected to an electronic circuit (not illustrated) of the electronic device through a flexible wiring board (not illustrated) or a connector (not illustrated).

In the above configuration, a user operates the electronic device by touching an upper surface of substrate 11 with his or her finger in response to display of the display device provided behind the touch panel in a state where voltage is applied from the electronic circuit to upper electrodes 12 sequentially. Electrostatic capacitance between conductive layers 14 and 15 is changed at a touched portion, and the touched portion is detected by the electronic circuit, whereby switching of various functions of the electronic device can be achieved.

For example, in a state where a plurality of menus are displayed on the display device provided behind the touch panel, the user touches the upper surface of substrate 11 with his or her finger at a portion corresponding to a desired menu. Then, a part of electrical charge of conductive layer 15 is conducted to the finger, resulting in a change in the capacitance between conductive layers 14 and 15 at the touched portion on the touch panel. Then, the electronic circuit detects the capacitance change, thus allowing a desired menu to be selected.

In the present invention, upper adhesive layer 13, the plurality of conductive layers 14 and 15 each made of the light transmissive resin in which metal thin wires are dispersed, and lower adhesive layer 17 are formed on the lower surface of light transmissive substrate 11 in a stacked manner. This configuration allows reduction of a thickness of the touch panel excluding the substrate 11 to a range from 10 μm to 60 μm, thereby achieving thickness reduction of the entire touch panel. In other words, a thickness from the upper surface of upper adhesive layer 13 to the lower surface of lower adhesive layer 17 is in a range from 10 μm to 60 μm.

Moreover, the plurality of thin foil-like lower electrodes 16 are covered by upper adhesive layer 13 and lower adhesive layer 17, the plurality of upper electrodes 12 each having comparatively larger thickness are connected respectively to lower electrodes 16, and upper electrodes 12 formed on the lower surface of substrate 11 are connected to the electronic circuit. This prevents corrosion of lower electrode 16 due to humidity, allowing reliable operation.

Moreover, protrusion 12A is formed on the lower surface of upper electrode 12 so as to contact lower electrode 16, allowing upper electrode 12 and lower electrode 16 to be connected through protrusion 12A. This allows reliable connection between upper electrode 12 and lower electrode 16.

Hollow carbon thin wires each having a diameter in a range from 0.5 nm to 50 nm and a length in a range from 0.5 μm to 10 μm or carbon particles each having a particle diameter in a range from 2 nm to 100 nm may be distributed, in addition to the metal thin wires, in the light transmissive resin of each of conductive layers 14 and 15. This enables absorption of reflection light from the metal thin wires to allow reduction of diffuse reflection.

As is clear from the above description, the present application is featured in that lower electrodes 16 formed corresponding respectively to conductive layers 14 and 15 are connected to upper electrodes 12 through protrusions 12A. Moreover, the above-described arrangement state of conductive layers 14 and 15 advantageously reduce the entire thickness of the touch panel.

In the description of the above embodiment, terms related to directions such as “upper surface”, “lower surface”, “upper”, “lower”, “front-rear”, and “left-right” each indicate a relative direction only depending on a relative positional relationship among components of the touch panel such as the substrate, conductive layer, and insulating layer and do not indicate an absolute direction such as a vertical direction.

A touch panel according to the present embodiment includes a light transmissive substrate, an upper electrode, an upper adhesive layer, a conductive layer, a lower electrode, a lower adhesive layer, and a protrusion. The upper electrode is formed on a lower surface of the substrate. The upper adhesive layer is formed on the lower surface of the substrate and a lower surface of the upper electrode and has a light transmissive property. The conductive layer is formed on a lower surface of the upper adhesive layer and has a light transmissive property. The lower electrode is formed on the lower surface of the upper adhesive layer and connected to the conductive layer. The lower adhesive layer is formed on the lower surface of the upper adhesive layer, a lower surface of the conductive layer, and a lower surface of the lower electrode and has a light transmissive property. The protrusion is formed in the upper adhesive layer so as to connect the upper electrode and lower electrode. The upper adhesive layer, conductive layer, lower adhesive layer are formed on the lower surface of the substrate in a stacked manner, so that a thickness of the entire touch panel can be reduced. The protrusion formed on the lower surface of the upper electrode contacts the lower electrode, thereby achieving stable connection between the upper and lower electrodes. Thus, a touch panel allowing reliable operation can be obtained.

The touch panel according to the present invention has advantages in that the entire thickness thereof can be reduced and reliable operation can be ensured and is thus very useful as an operation unit of various electronic devices.

What is claimed is:

1. A touch panel comprising:
a light transmissive substrate;
an upper electrode formed on a lower surface of the substrate;
a light transmissive upper adhesive layer formed on the lower surface of the substrate and a lower surface of the upper electrode;
a light transmissive conductive layer formed on a lower surface of the upper adhesive layer;
a lower electrode formed on the lower surface of the upper adhesive layer and connected to the conductive layer;
a light transmissive lower adhesive layer formed on the lower surface of the upper adhesive layer, a lower surface of the conductive layer, and a lower surface of the lower electrode; and
a protrusion formed in the upper adhesive layer so as to connect the upper electrode and lower electrode.

2. The touch panel according to claim 1,
wherein a contact area between the protrusion and the upper electrode is larger than a contact area between the protrusion and the lower electrode.

3. The touch panel according to claim 1,
wherein a cross-section of the protrusion parallel to the substrate is reduced toward the lower electrode.

4. The touch panel according to claim 1,
wherein a thickness from an upper surface of the upper adhesive layer to a lower surface of the lower adhesive layer ranges from 10 μm to 60 μm.

5. The touch panel according to claim 1,
wherein the lower electrode has a portion formed by a thin wire having a line width of 200 μm or less, or has a portion formed into a lattice shape.
